(19) United States
(12) Patent Application Publication
(10) Pub. No.: US 2009/0208627 A1
(43) Pub. Date: Aug. 20, 2009

(54) Diacetyl Derivatives

(75) Inventor: Luca Turin, London (GB)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Flexitral , Inc., Chantilly, VA (US)

(21) Appl. No.: 11/995,386

(22) PCT Filed: Jul. 12, 2006
(86) PCT No.: PCT/US2006/026827

§ 371 Date: Nov. 10, 2008

Related U.S. Application Data
(60) Provisional application No. 60/698,013, filed on Jul. 12, 2005.

(51) Int. Cl. A23L 1/226

(52) U.S. Cl. 426/534

(57) ABSTRACT

An improved method for imparting a butter flavor to a product, the method comprising adding to the product an organoleptically effective amount of diacetyl, the improvement comprising substituting for the diacetyl, an organoleptically acceptable derivative of diacetyl having the formula: (formula I), or an organoleptically acceptable salt thereof, as well as compositions for carrying out the method and products and articles of manufacture comprising the additive.

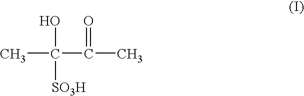

### FIELD OF THE INVENTION

The present invention relates to certain additives that impart a butter flavor to food products.

### BACKGROUND OF THE INVENTION

There are a large number of aromachemicals that are used to modify the flavor and/or fragrance of food and drink products and/or to modify the fragrance of products such as consumer products. Some aromachemicals are highly reactive and may potentially be dangerous to the health of people working in environments in which these products are used. It is an object of the present invention to provide derivatives of a harmful compound which is far less likely to be a danger to health but which can also be used to provide flavors and fragrances.

One flavor that is very popular with consumers is butter flavor. Butter-flavored foods are highly desirable and widely consumed. For example, in recent years butter-flavored microwavable popcorn has become extremely popular.

In fresh butter, precursors to lactones and free lactones exist in small concentrations. Free lactones exist in the lipid phase of butter, where they have higher threshold values. Despite their low concentration in fresh butter, free lactones are important flavorants, which act in an additive manner to impart the perceptible sweet, fruity flavors characteristic of butter. Upon heating, the lactone precursors are converted to lactones and their total concentration rises above their Flavor Threshold Value (FTV). Thus, they provide the rich flavor notes commonly associated with heated foods containing butterfat. Lactones in butter are also the major source of flavor in confections and high-quality candies where they provide the unique, pleasurable flavors associated with these products.

Dimethyl sulfide, originally derived from the feed of cows, occurs in butter at concentrations above its Flavor Threshold Value (FTV). Dimethyl sulfide helps to smooth the harsher flavor notes of acidic substances in butter and is also largely responsible for the freshly cooked note associated with freshly churned butter.

Although the exact role of aliphatic aldehydes in butter flavor has not been defined, it is known that they are important. They are typically present in concentrations below their Flavor Threshold Value (FTV), particularly since they have low thresholds and produce desirable creamy, buttery flavor at very low concentrations. At high concentrations, they lead to the oxidized off-flavors associated with butter oxidation. Aldehydes can also be found in butter cultures used in the manufacture of cultured butter.

Indole and skatole are two additional flavor compounds which are present in butter and which contribute to its flavor. Phenol and cresol are of borderline significance but also play a role in the flavor of butter.

A number of additives have been developed over the years that impart a butter flavor to food products. For example, Commercial Creamery Co. has developed a new butter flavor comprising an enzyme modified butter powder. Also on the market as a butter substitute is Acetyl Methyl Carbinol (Acetoin).

The most popular butter flavor additive employed today, however, is diacetyl [2,3-butanedione] which has the formula:

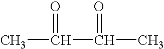

Diacetyl [sometimes marketed as “Starter Distillates”] has a FTV of flavor threshold of 0.10 mg/L. Carbonyl compounds make a particularly significant contribution to the flavor of fermented dairy products. Diacetyl is one of the most important carbonyls to the flavors of these products. It has a buttery, nut-like flavor. Diacetyl may be produced via the fermentation of citrate-containing material bacterial culture containing alpha-acetolactic acid, acidifying the bacterial culture which is then water vapor distilled in the presence of oxygen for oxidation of alpha-acetolactic acid to diacetyl. [Source book of Flavors, Reineccius, G, Ed. 1994 Chapman and Hall, New York].

Butter-flavored foods are highly desirable and widely consumed. For example, in recent years butter-flavored microwavable popcorn has become extremely popular. It is widely recognized within the art of producing and using butter flavors that diacetyl and butyric acid are key flavor components easily lost via evaporation (Merker, U.S. Pat. No. 2,773,772; Buhler, U.S. Pat. No. 3,653,921; Millisor, U.S. Pat. No. 4,384,008; Bakal, U.S. Pat. No. 4,414,229; and Darragh, U.S. Pat. No. 3,867,556). Buhler, U.S. Pat. No. 3,653,921, for example, notes the prior art has suggested the incorporation of selected lactones, diacetyl, constituents of cultured butter, short-chain fatty acids and alcohols and other chemical compounds into oleaginous foodstuffs to impart a butter flavor. Millisor, U.S. Pat. No. 4,384,008, discloses a specific formulation made from diacetyl, several short-chain fatty acids and lactones for preparing a butter flavored oil.

Diacetyl (2,3 butanedione) is an extremely powerful and highly volatile (b.p. 88C) odorant. The National Institute for Occupational Safety and Health (NIOSH), a federal workplace safety agency, believes that diacetyl may be the component of butter flavoring responsible for more than a dozen cases of a respiratory illness called “popcorn workers' lung” it has discovered in the past four years [Niosh Health Hazard Evaluation Report, HETA-2002-0408-2915 (October, 2003).

Diacetyl is a reactive molecule, attacks arginine residues in proteins and is known to inhibit enzymes. NIOSH describes the adverse effects of diacetyl: Potential symptoms: Eye, mucous membrane, respiratory system, skin irritation; persistent cough, phlegm production, wheezing, dyspnea (shortness of breath); unusual fatigue; episodes of mild fever or generalized aches; severe skin rashes. Health Effects: Irritation-Eyes, Nose, Throat, Skin (HE15); Suspected cumulative lung damage—-bronchiolitis obliterans (HE10) Affected organs: Eyes, respiratory system, skin.

Other authors have also pointed out the dangers of exposure to diacetyl: DiFolco, Forum Casualty & Environment, Issue no. 14-Dec., 2004; Fix, BrewingTechniques' July/August 1993 [“- - - the involvement of diacetyl in sarcina sickness was discovered early, but it was not until 1939 that Shimwell linked this compound with the taste and smell of butter - - - ”]; Kreiss, K., Gomaa, A., Kullman, G., Fedan, K., Simoes, E. J. and Enright, P. L.: Clinical bronchiolitis obliterans in workers at a microwave-popcorn plant. New Eng. J. Med. 347(5): 330-338, 2002; Lockey, J., McKay, R, Barth, E., Dahlsten, J. and Baughman, R.: Bronchiolitis obliterans in the food flavoring industry [abstract]. Am. J. Respir. Crit. Care Med. 165: A461, 2002; Parmet, A. J. and Von Essen, S.: Rapidly progressive, fixed airway obstructive disease in popcorn workers: a new occupational pulmonary illness? [Letter] J. Occup. Environ. Med. 44(3): 216-218, 2002; Hubbs, A. F., Battelli, L., Goldsmith, W. T., Porter, D. W., Frazer, D., Friend, S., Schwegler-Berry, D., Mercer, R. R., Reynolds, J. S., Grote, A., Castranova, V., Kullman, G., Fedan, J. S., Dowdy, J. and Jones, W. G.: Necrosis of nasal and airway epithelium in rats inhaling vapors of artificial butter flavoring. Toxicol. Appl. Pharmacol. 185: 128-135, 2002. Boggaram, V. and Mannervik, B.: Essential arginine residues in the pyridine nucleotide binding sites of glutathione reductase. Biochim. Biophys. Acta 701(1): 119-126, 1982; Borders, C. L. Jr., Saunders, J. E., Blech, D. M. and Frovich, I.: Essentiality of the active-site arginine residue for the normal catalytic activity of Cu, Zn superoxide dismutase. Biochem. J. 230(3): 771-776, 1985. Riordan, J. F.: Arginyl residues and anion binding sites in proteins. Mol. Cell. Biochem. 26(2): 71-92, 1979;

NIOSH has called for stringent safety measures to be implemented, and has set out the following criteria as guidelines to the search for a substitute for diacetyl:

1] Exercise extreme care when selecting substitutes.

2] Consider the possible adverse health effects of any candidate substitutes.

3] Remember that as a general rule, flavoring formulations designed to release less volatile chemicals or respirable powder into the air during handling may pose less risk to workers.

It is an object of the present invention to provide a substitute for diacetyl that imparts the same intense butter flavor to food products without the above-noted attendant disadvantages.

### SUMMARY OF THE INVENTION

The above and other objects are realized by the present invention, one embodiment of which relates to an improved method for imparting a butter flavor to a product, the method comprising adding to said product an organoleptically effective amount of diacetyl, wherein the improvement comprises substituting for diacetyl, an organoleptically acceptable derivative of diacetyl having the formula:

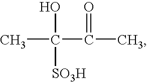

or an organoleptically acceptable salt thereof.

A still further embodiment of the invention concerns a product comprising an organoleptically effective amount of an additive to impart a butter flavor thereto, wherein the additive comprises an organoleptically acceptable diacetyl derivative having the formula:

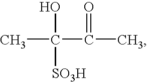

or an organoleptically acceptable salt thereof.

Another embodiment of the invention relates to an article of manufacture comprising the above-described product.

A still further object of the invention relates to an article of manufacture in kit form comprising separate packaging materials and a food product contained within one of the packaging materials, and an organoleptically acceptable food additive contained within the other of the packaging materials and wherein at least one of the packaging materials comprises a label which indicates that the food additive can be used for imparting a butter flavor to the food product, and wherein the food additive is an organoleptically acceptable diacetyl derivative having the formula:

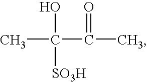

or an organoleptically acceptable salt thereof.

An additional embodiment of the invention relates to a composition in unit dosage form comprising an organoleptically acceptable derivative of diacetyl and an organoleptically acceptable carrier therefore, said diacetyl derivative having the formula:

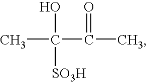

or an organoleptically acceptable salt thereof, wherein the derivative is present in said composition in an amount sufficient to impart an organoleptically effective butter flavor to a product to which the composition is added.

### DETAILED DESCRIPTION OF THE INVENTION

Finding a substitute for diacetyl is made more difficult by the fact that it is such a small molecule, where even the smallest structural change has a large effect on its odor and flavor characteristics.

The present invention is predicated on the approach recommended by NIOSH (supra) in which only the volatility of the additive is reduced, without substantially altering the altering the flavorant itself.

Diacetyl is known to form an adduct with sodium hydrogen sulfite [2-butanesulfonic acid, 2-hydroxy-3-oxo-, monosodium salt-CAS 13489-36-6]. See also French patent 2,845,903. This adduct is in equilibrium with the starting materials and, in practice, releases small amounts of diacetyl and sulfite continuously. Although it is known that sulfites are commonly used as food preservatives and may be used in food products in amounts up to 10 ppm without special labeling, the above-described adduct has never been used in foods previously. The above-mentioned French patent discloses that the adduct is useful in hair care products as a straightening agent. The vapor pressure of the diacetyl adduct is negligible, thereby rendering it virtually odorless. It is usually obtained and used in the form of a water-soluble salt, such as, e.g., an alkali metal (sodium) salt. Since it is water soluble, it can therefore be sprayed directly onto foodstuffs safely. The flavor imparted by the adduct is dominated by diacetyl, since at low concentrations, the sulfite taste and flavor is imperceptible. Methods for the preparation of the adduct are well known. Briefly, diacetyl is dissolved in water and an equimolar amount of sodium hydrogen sulfite (i.e., bisulfite) is added gradually over a period of 20 minutes. The color of the reaction mixture turns from yellow to white. At completion of the reaction, the water is evaporated and the adduct is obtained as a crystalline white powder with little or no odor.

Suitable sulfite or sulfite generating species for use in this reaction include water-soluble sulfites, bisulfites, hydrosulfites, metabisulfites and sulfur dioxide. For example, ammonium or alkali metal, particularly sodium or potassium sulfites, bisulfites, hydrosulfites and metabisulfites. Particularly preferred are sodium metabisulfite, sodium sulfite, sodium bisulfite and sodium hydrosulfite, potassium sulfite, potassium bisulfite, potassaium hydrosulfite and potassium metabisulfite, ammonium sulfite and ammonium bisulfite and sulfur dioxide. Sulfites and metabisulfites of alkaline earth metals such as calcium and barium may also be used. Sulfites and sulfite generating species which produce sodium salts are preferred.

The reaction can be summarized as follows:

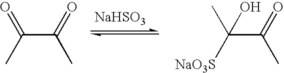

This adduct is in equilibrium with the starting materials and, in practice, releases small amounts of diacetyl and sulfite continuously. The diacetyl starting material is responsible for the butter odor. The sulfite adduct itself is virtually odorless.

It will be understood by those skilled in the art that the adduct (or its salts) may be incorporated into any desired food or article manufactured therefrom much in the same manner and in the amounts employed in the industry for incorporating diacetyl in foods. Moreover, any food or food product or article which may be flavored by incorporating diacetyl therein may be also be flavored with the adduct of the invention. Typical such food products include popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla, buttermilk, and the like.

For example, butter flavor systems employing the derivatives of this invention designed for use with microwave popcorn products may include about 0.5-10% diacetyl derivative, 3-12.5% salt, 0.05-0.25% color, and 75%-95% water or oil (or partially hydrogenated vegetable oil) together with minor amounts of compounds known in the art to retard the development of off-flavors in oils and fats (for example, antioxidants).

The methods described herein are also applicable for the formation of sulfite adducts of other diones such as, e.g., 1,2-cyclohexanedione, 3,4-dimethyl-1,2-cyclopentadione, 3,5-dimethyl-1,2-cyclopentadione, 2,3-heptanedione, 2,3-hexanedione, 3,4-hexanedione, 1-methyl-2,3-cyclohexadione, 3-methylcyclopentane-1,2-dione, 5-methyl-2,3-hexanedione.

A particularly preferred adduct to be employed in the practice of the invention is the sodium salt of the diacetyl adduct [2-butanesulfonic acid, 2-hydroxy-3-oxo-, monosodium salt (CAS 13489-36-6)]

For the purposes of the description of the invention herein, the following definitions apply:

The term, “aromachemical”, as used herein refers to a chemical compound that has fragrance and/or flavor characteristics

The term, “organoleptic”, as used herein, refers to compounds of the invention which stimulate the sense of smell or taste, and are thus perceived as having a characteristic odor and/or flavor.

An “organoleptically effective amount” is a level or amount of the compounds(s) present in a material at which the incorporated compound(s) exhibit(s) a sensory effect acceptable to a consumer, e.g. by stimulating the sense of smell or taste.

The term, “organoleptically acceptable”, refers to materials compatible with the derivatives of the invention and which do not affect the organoleptic properties of the latter

“Unit dosage form” refers to a composition containing a predetermined amount of diacetyl derivative in a form for application to a product to impart organoleptically acceptable butter flavor thereto.

“Organoleptically acceptable carrier” refers to the material employed for delivery of the diacetyl derivative to the desired substrate, e.g., water or other solvent in which the derivative is soluble or may be suitably suspended.

It is thought that many of the problems associated with the use of diacetyl are due to its volatility and reactivity. Diacetyl has a vapour pressure of 178 mm. On the other hand, the vapor pressure of the diacetyl adduct is negligible, i.e., comparable to that typically exhibited by salts of strong acids. Accordingly, the derivative is virtually odorless. Additionally, the increase in molecular weight of the adduct compared to diacetyl also reduces the volatility of the latter.

In current methods for the manufacture of popcorn, particularly microwave popcorn, the corn kernels are sprayed with an oily composition comprising flavourings. These flavouring may include salt and/or sugar, diacetyl to provide a butter-like flavour and other flavorings such as herbs and species or sweet flavors such as toffee or caramel. The oil may be any acceptable food oil and may include butter.

The oily composition described above is typically sprayed onto the corn kernels at room temperature or at a temperature slightly above room temperature, for example at a temperature from 15 to 60° C. In the case of microwave popcorn, following spraying, the corn kernels are packaged and sealed in a suitable container such as a bag until the time of use.

The present invention also provides food products such as potato crisps or corn kernels which are coated with a compound of the invention or with a composition containing a sulfite adduct of diacetyl.

The popcorn products typically comprise from about 100 to 1000 ppm of the diacetyl adduct of the present invention based on the total weight of the coated corn kernels.

As mentioned above, the compounds of the invention are not themselves aromachemicals, although they may exhibit a slight flavor or fragrance of the aromachemical on which they are based under certain circumstances due to the equilibrium between the aromachemical and the sulfite adduct. Thus, corn kernels or other products having a coating comprising a compound of the invention will have little or no smell or taste which can be attributed to the aromachemical on which the sulfite adduct is based.

In order to release the flavor or fragrance of the sulfite adducts it is necessary to expose the compound of the invention to conditions which cause the adduct to break down and release the aromachemical. For example, it is well known that changes in pH can cause sulfite adducts of carbonyl compounds to break down to regenerate the carbonyl compound. For example, it is thought that weakly alkali environments may cause the compounds of the present invention to break down to regenerate the parent aromachemical. Weakly alkali environments include aqueous environments having a pH of 8 or greater, for example between 8.5 and 10. Some adducts may break down in acid environments. For others, vigorous heating may be sufficient to break down the adduct and release the aromachemical.

In the case of, for example, corn kernels having a coating comprising a sulfite adduct of diacetyl, the corn kernels will have a weak buttery smell (of course it will be appreciated that this will depend at least to some extent on whether the corn kernels have been coated with any other compounds that exhibit a buttery smell).

It will be appreciated that the coated corn kernels are not in a condition to be eaten and that they must first be heated so that they “pop”. When corn kernels are heated past the boiling point of water, water present in the kernels begins to turn to steam, generating an internal pressure, thought to be about 9 atmospheres. The steam is held tightly in the kernel and the pressure build up is eventually sufficient to rupture the pericap of the kernel, producing the product that is consumed.

It has surprisingly been found that when the corn kernels coated with a sulfite adduct of diacetyl of the present invention are subjected to heating, for example in a microwave oven or in a heated pan, the adduct is broken down to generate diacetyl and thus provide a buttery smell and taste.

In some instances, the moisture and heat present during this process in sufficient to cause the adduct to break down. In other instances, it may be necessary to induce break down of the adduct by the introduction of an acid or base.

The flavor imparted when using the compounds of the present invention as described above is dominated by the diacetyl since at low concentrations, the sulfite taste and flavor is imperceptible.

The present invention also provides an article of manufacture in kit form comprising two or more separately packaged components wherein one component comprises a food product and another component comprises an organoleptically acceptable food additive comprising a diacetyl adduct of the invention.

The present invention also provides a composition in unit dosage form comprising an adduct of the invention and an organoleptically acceptable carrier therefore, wherein the compound is present the composition in an amount sufficient to impart an organoleptically effective flavor to a product to which the composition is added when the adduct is broken down to release the aromachemical. The unit dosage form is preferably packaged with a label which indicates the butter flavor the food additive can impart. If necessary, the label may additionally or alternatively include instructions as to break down the adduct and release the aromachemical on which the adduct is based and thereby release the flavor of that aromachemical.

Any suitable unit dosage form may be used. For example the unit dosage form may be contained in a container such as a sachet which is opened before use. Alternatively, the unit dosage form may be contained in a gas permeable container such as a gas permeable sachet.

As one specific example, rather than coating corn kernels as described above, it may be possible to provide a sachet which contains a compound of the invention such as a sulfite adduct of diacetyl in solid form with an organoleptically acceptable base producing solid such as sodium hydrogen carbonate or sodium carbonate. This dosage unit could be contained within a bag containing corn kernels, for example, within a bag of microwave popcorn. Heating the bag of corn kernels containing the unit dosage form releases steam as the corn kernels “pop”, the steam penetrates the gas permeable sachet and causes the production of a base, which then breaks down the adduct. It will be appreciated that in this text any reference to the use of a compound of the invention or a product containing such a compound is intended to refer to the use of or a product containing an organoleptically effective amount of a compound of the invention.

1. In a method for imparting a butter flavor to a product, said method comprising adding to said product an organoleptically effective amount of diacetyl, the improvement comprising substituting for said diacetyl, an organoleptically acceptable derivative of diacetyl having the formula: 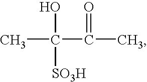
or an organoleptically acceptable salt thereof.

2. The method of claim 1 wherein said salt is a physiologically acceptable salt.

3. The method of claim 2 wherein said salt is an alkali metal.

4. The method of claim 3 wherein said salt is a sodium salt.

5. The method of claim 1 wherein said product is a food product.

6. The method of claim 5 wherein said food product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

7. A process according to claim 1, which includes the step of subjecting the additive to conditions which cause the additive to break down to release the parent diacetyl.

8. A process according to claim 7, wherein the step of subjecting the derivative to conditions which cause the derivative to break down comprises subjecting the compound of formula (I) or (II) to acidic or basic conditions.

9. A product containing an organoleptically effective amount of an additive to impart a butter flavor thereto, said additive comprising an organoleptically acceptable diacetyl derivative having the formula: 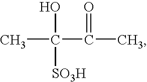
or an organoleptically acceptable salt thereof.

10. The product of claim 9 wherein said salt is a physiologically acceptable salt.

11. The product of claim 10 wherein said salt is an alkali metal.

12. The product of claim 11 wherein said salt is a sodium salt.

13. The product of claim 9 comprising a food product.

14. The product of claim 13 wherein said food product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

15. An article of manufacture comprising the product of claim 9.

16. An article of manufacture in kit form comprising separate packaging materials and a product contained within one of said packaging materials, and an additive contained within the other of said packaging materials and wherein at least one of said packaging materials comprises a label which indicates that said additive can be used for imparting a butter flavor to said product, and wherein said additive is an organoleptically acceptable diacetyl derivative having the formula: 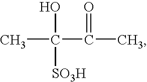
or an organoleptically acceptable salt thereof.

17. The article of manufacture of claim 16 wherein said salt is a physiologically acceptable salt.

18. The article of manufacture of claim 17 wherein said salt is an alkali metal salt.

19. The article of manufacture of claim 18 wherein said alkali metal is sodium.

20. The article of manufacture of claim 16 wherein said product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

21. A composition in unit dosage form comprising an organoleptically acceptable derivative of diacetyl and an organoleptically acceptable carrier therefore, said diacetyl derivative having the formula: 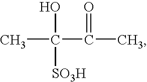
or an organoleptically acceptable salt thereof, wherein the derivative is present in said composition in an amount sufficient to impart an organoleptically effective butter flavor to a product to which the composition is added.

22. The composition of claim 21 wherein said salt is a physiologically acceptable salt.

23. The composition of claim 22 wherein said salt is an alkali metal salt.

24. The composition of claim 23 wherein said alkali metal is sodium.

25. The composition of claim 21 wherein said product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

26. The use of an organoleptically acceptable additive to impart a butter flavor to a product wherein said additive has the formula: 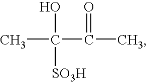
or an organoleptically acceptable salt thereof.

27. The use of claim 26 wherein said product is a food product.

28. The use of claim 26 wherein said salt is a physiologically acceptable salt.

29. The use of claim 28 wherein said salt is an alkali metal salt.

30. The use of claim 29 wherein said alkali metal is sodium.

31. The use of claim 26 wherein said product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.
